(19) United States
(12) Patent Application Publication
(10) Pub. No.: US 2024/0394325 A1
(43) Pub. Date: Nov. 28, 2024

(54) RANDOM QUBO GENERATION FOR BENCHMARKING OF ANNEALERS

(71) Applicant: Dell Products L.P., Round Rock, TX (US)

(72) Inventors: Victor Fong, Medford, MA (US); Brendan Burns Healy, Haddonfield, NJ (US); Miguel Paredes Quiñones, Campinas (BR); Kenneth Durazzo, Morgan Hill, CA (US); Rômulo Teixeira de Abreu Pinho, Niterói (BR)

(21) Appl. No.: 18/321,208

(22) Filed: May 22, 2023

(51) Int. Cl. G06F 17/11

(52) U.S. Cl. CPC G06F 17/11

(57) ABSTRACT

One method includes receiving a request concerning resolution of a QUBO (quadratic unconstrained binary optimization) problem, randomly generating benchmark QUBOs, obtaining information, including telemetry and solutions, concerning execution of the benchmark QUBOs on each annealer in a group of annealers, and comparing respective performances of each of the annealers. Each of the QUBOs is associated with a respective QUBO matrix, and each QUBO matrix having the same size and density.

### FIELD OF THE INVENTION

Embodiments of the present invention generally relate to evaluation of computing infrastructures. More particularly, at least some embodiments of the invention relate to systems, hardware, software, computer-readable media, and methods, for enabling comparison of the performance of various annealers.

### BACKGROUND

Competing service providers, such as cloud service providers, are generally only incentivized to report the features of their services, and positive results resulting from the use of those services. However, not all cloud providers are the same, and each may have their own limitations. In the case of basic services such as cloud storage for example, limitations such as I/O speed, backups, and data storage capacity, are easy to determine and understand. However, for complicated hardware, such as quantum annealers, the limitations may be difficult for a user, such as a customer, to independently ascertain.

In more detail, typical end-users benefiting from the advantage provided by quantum, or non-quantum, annealers do not fully appreciate how the annealers work. Complicating this situation is the fact that vendors are not incentivized to report negative fidelity data and metrics from their systems. Thus, a user cannot readily and directly compare vendor performance without paying for time on, or purchasing, an annealing system from each competing vendor. However, this is generally not a practical or viable approach for the user to take. Finally, because annealers may be stochastic in nature, it is possible that they may not provide the same solution to a problem every time the problem is solved. This property of annealers may further complicate the efforts of a user to compare vendor performances.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture according to one example embodiment.

FIG. 2 discloses respective energy landscapes and annealer paths for problems of differing complexity.

FIG. 3 discloses aspects of a method according to one example embodiment.

FIG. 4 discloses aspects of a computing entity configured and operable to perform any of the disclosed methods, processes, and operations.

### DETAILED DESCRIPTION OF SOME EXAMPLE EMBODIMENTS

Embodiments of the present invention generally relate to evaluation of computing infrastructures. More particularly, at least some embodiments of the invention relate to systems, hardware, software, computer-readable media, and methods, for enabling comparison of the performance of various annealers.

In one example embodiment, a broker may randomly generate QUBO problems, or simply ‘QUBO,’ that may then be distributed to various vendors for execution on respective vendor systems. The broker may receive, from the vendors, performance telemetry resulting from execution of the QUBO problems on the vendor systems. This telemetry information may be provided by the broker to customers of the vendors so as to enable the customers to compare the performance of the different vendor systems, such as by comparing solution fidelity, or runtime, for example, of the different vendor systems. The random nature of the generation of the QUBO problems may prevent a vendor from anticipating a particular type of problem and then forging results and/or reconfiguring the vendor system to perform well for a particular QUBO.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a user without deep technical knowledge of quantum systems and operations may nonetheless be able to effectively compare the performance of different quantum systems. An embodiment may enable the comparison of the performance of various annealers of different types. An embodiment may enable a user to compare quantum system performance with respect to resolution of problems similar in material respects to a problem that the user needs solved. Various other advantages of one or more embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment

Following is a brief discussion concerning various concepts that may relate to one or more embodiments. This discussion is not intended to limit the scope of the invention in any way.

In general, quantum annealers include computational devices configured to solve combinatorial optimization problems, such as QUBO (quadratic unconstrained binary optimization) problems, also referred to herein simply as ‘QUBO’s. A model of a QUBO may be expressed by an optimization problem, thus:

QUBO: minimize the function y=x^{t}Qx, where,
x is a vector of binary decision variables, and
Q is a matrix of constants sometimes referred to as a QUBO matrix.

QUBO problems are a type of combinatorial optimization problem such that many real world problems may be encoded in the format (where x∈{0,1}ⁿ):

$$H ( x ) = {\sum }_{i < j} {q}_{i , j} {x}_{i} {x}_{j} + {\sum }_{i} {q}_{i} {x}_{i}^{2} = {x}^{T} Qx$$

Quantum annealing (QA) processes may attempt to interpolate between a static problem-independent Hamiltonian for which the ground state may be efficiently prepared, and a final Hamiltonian whose ground state yields the desired answer. The QA system then linearly interpolates between H₀ and H_{f} (H_{f}=Q).

$$H ( t ) = α ( t ) {H}_{0} + β ( t ) {H}_{f}$$

Where: H_{f} is the Hamiltonian of the problem that is to be solved. This system represented by H(t) evolves following the time-dependent Schrodinger equation. The system is manipulated in the manner of create quantum tunneling effect that makes that the system stay closer to the ground state.

### B. Aspects of an Example Architecture and Associated Operations

The following is a discussion of aspects of example operating environments for various embodiments of the invention. This discussion is not intended to limit the scope of the invention, or the applicability of the embodiments, in any way.

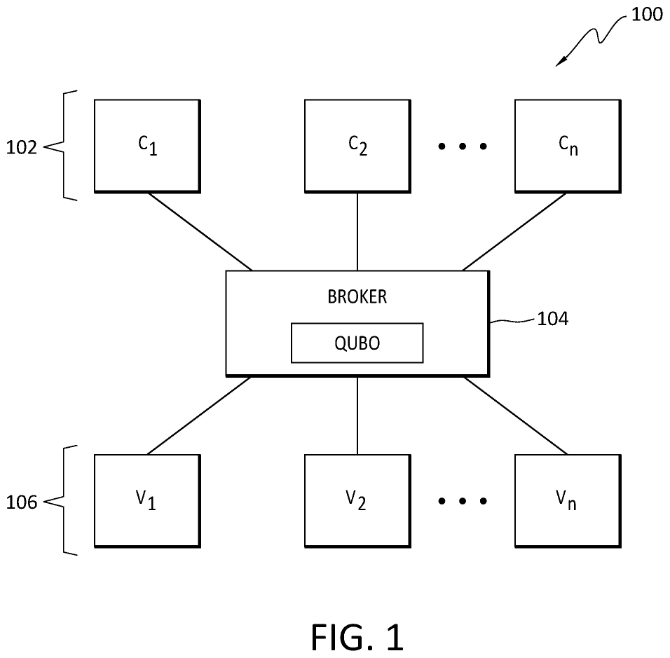

With particular attention now to FIG. 1, an architecture according to one example embodiment is generally denoted at 100. In one embodiment, the architecture 100 may comprise various customers 102 that may each have one or more QUBOs to be solved. The customers 102 may communicate with a broker 104 that may act as a middleman between the customers 102 and one or more quantum vendors 106. Thus, an embodiment of a broker may operate as a technical middleman, and may not necessarily perform any commercial function, although the broker may do so in an embodiment.

In general, the quantum vendors 106 may each comprise various computing infrastructures, including quantum computing infrastructures and classical computing infrastructures, either or both of which may comprise various types of annealers that include annealer hardware. Any of the computing infrastructures of the vendors 106 may be configured to perform simulated annealing, and/or annealing on annealing hardware. Example annealing hardware may include, but is not limited to, CPU (central processing units) and GPU (graphics processing units). Thus, an annealer may be a simulated annealer, or a real digital annealer.

The problem solving capabilities of the infrastructures may be offered by the quantum vendors 106 as a service to the customers 102. In some instances, the customers 102 may lack the knowledge and sophistication to be able to meaningfully compare the performance of one vendor 106 with the performance of one or more other quantum vendors 106. As discussed in more detail below, the broker 104 may facilitate, or perform, a meaningful comparison of vendor performances, for the benefit of one or more of the customers 102.

### B.1 Example Broker Operations

In an embodiment, the broker 104 may periodically submit the same randomized QUBO, which may be generated by the broker 104 or another entity, to each vendor 106. The vendors 106 may run the randomized QUBO on their respective infrastructures and provide the results, that is, the QUBO solutions to the broker 104 for evaluation. The broker 104 may then evaluate the performance of the vendors 106 by comparing the results received from the different vendors 106 and identifying which result was best. In an embodiment, the randomized QUBO may be a problem whose optimal solution is known by the broker 104, and which is known to be difficult to solve. Thus, the randomized QUBO may be a useful way to determine if a given annealer of a vendor 106 can reach the best-known solution. A QUBO may be configured to fit onto each respective constituent system of the vendors 106, and so may be limited by the size of the smallest vendor, qubit-wise. However scaled up problems may be submitted to larger vendors 106. It is noted that vendor 106 parameters such as qubit availability, and connectivity, comprise data that are typically available to, and mostly easily understood by, a customer or other end user.

### B.2 Example QUBO Problems

In general, the relative difficulty of a QUBO is related to its number of eigenvalues, that is, a larger number of eigenvalues represents a relatively more difficult problem to solve than a problem with fewer eigenvalues. This characteristic of QUBOs tends to create a challenging energy function landscape that may have various local minima, each comprising a possible solution.

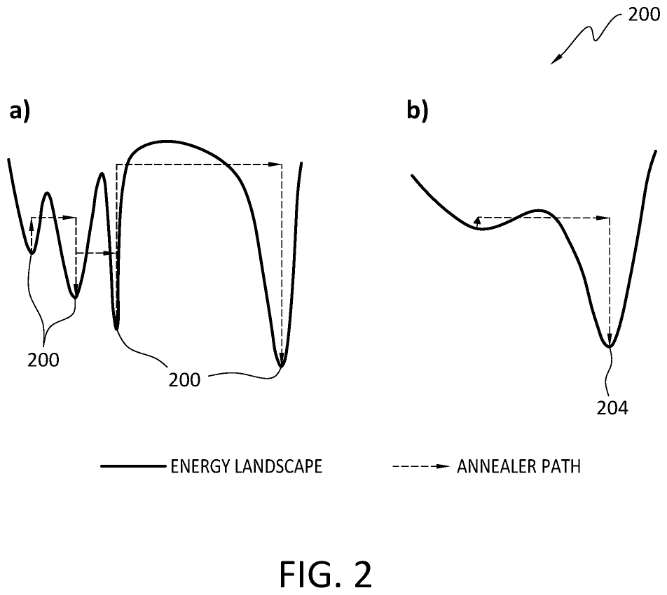

The various constraints and parameters of a combinatorial optimization problem may be transformed into a QUBO matrix, which may ultimately be fed to an annealer, or other QUBO solver. That is, the QUBO matrix may comprise a compiled QUBO that is ready for execution. Another source of difficulty in QUBO solution approaches concerns this QUBO matrix, which may be considered as ‘sparse’ when many/most of the values in the matrix are zero, or ‘dense’ when many/most of the values in the matrix are non-zero. A dense QUBO matrix may tend to have more inter-variable interactions, or entanglement, than a sparse QUBO matrix. Thus a QUBO problem with a sparse matrix may tend to be easier to solve because that QUBO problem may more easily map to the physical restrictions of a target quantum annealer, and/or because that QUBO problem has fewer inter-variable interactions, that is, less entanglement. This is shown in the example graph 200 of FIG. 2.

Particularly, part a) of FIG. 2 discloses a circumstance where a problem to be solved by an annealer has numerous local minima 202, indicated by various energy states in the ‘energy landscape’ curve, each of which may constitute a solution to the QUBO. Thus, this QUBO may be relatively difficult to solve. By way of comparison, part b) of FIG. 2 discloses a circumstance where a problem to be solved by an annealer has only one significant local minimum 204, indicated by the ‘energy landscape’ curve, which may constitute a solution to the QUBO. Thus, this QUBO may be relatively easy to solve. It may also be observed from FIG. 2, that the annealer in the case of part a) may perform significantly more operations than are required to be performed by the annealer in the case of part b).

### B.3 QUBO Generation Processes

As noted earlier, an embodiment of the invention may operate to randomly generate one or more QUBOs that may be used to test the performance of quantum computing infrastructures, such as may be employed by one or more vendors of quantum computing services. In general then, an embodiment may enable greater transparency for a customer or consumer of quantum computing services by generating, and providing to the vendors, randomized, but uniform, QUBOs jobs to all the providers. One way to generate random benchmark QUBOS that are difficult to solve is to construct indefinite QUBOs with very similar absolute values of their respective eigenvalues. Now, to construct the final QUBO, an embodiment may randomly generate N orthonormal vectors subject to the conditions that a) half of those vectors have positive eigenvalues and the other half of those vectors have negative eigenvalues and b) all of these eigenvalues are similar in absolute value. How similar the eigenvalues are directly informs how difficult the QUBO is to solve.

This may be performed in various ways. High entanglement is also a consideration that makes a problem difficult to solve, due to the numerous qubit-qubit interactions in real quantum annealers.

In more detail, resolution of a particular QUBO problem may be considered in terms of the density of the QUBO matrix associated with that QUBO problem. For example, it was noted earlier herein that a relatively dense QUBO matrix may have a relatively large number of non-zero values, while a relatively sparse QUBO matrix may have a relatively large number of zero values. The more dense QUBO matrix implies a problem that is more difficult to solve than the problem with the sparse QUBO matrix, due at least in part to interactions between the non-zero values of the elements of the dense QUBO matrix.

In an embodiment, an example QUBO, in the form of an executable QUBO matrix, sent to a vendor may have a set matrix density, that is, all the vendors may receive a QUBO matrix of the same density, so that performance of the vendor infrastructures can be evaluated on a standard and consistent basis. In an embodiment, either positive (+) or negative (−) values may be assigned to any non-zero eigenvalues associated with the QUBO matrix. Further, the size of the benchmark QUBO matrix may be varied based on, for example, the size and nature of the consumer problems needed to be solved, and the available computing infrastructure at the vendors. As well, the size of the benchmark QUBO matrix may be varied so as to enable a determination as to, for example, when quantum computing capabilities are not needed and the problem, possibly due to a small size, can instead by effectively and efficiently solved with classical computing infrastructure, or when the problem may be more effectively and efficiently solved using real annealing hardware, rather than simply performing a simulation of the problem solution process.

In embodiment, the random nature of the QUBO generation process may help to prevent anticipation, by a vendor, of the nature of the problem to be submitted, and thus prevent, for example, forgery of results by the vendor, or specific hardware engineering by the vendor with the aim of ensuring that the vendor hardware performs well only specifically for the benchmark QUBOs. As well, randomization of the benchmark QUBOs may allow a broker, such as the broker 104, to, over time, test varying and different aspects of the vendor hardware performance which may not be detectable using conventional telemetry techniques.

The fact that, in an embodiment, both easy and difficult problems may be randomly generated may prevent a certain bias towards benefiting the most advanced, and thus expensive, annealers that can handle, high-entanglement problems more easily. Given the requirements of a particular SLA, a user or customer 102 may be satisfied, for example, with a solution of reasonable quality that tends to favor short execution times and a less expensive annealer, and the cost/benefit associated with a better quality solution may not be acceptable to, or needed by, this particular user.

### B.4 Result Comparison

After one or more randomized QUBOs have been run at the various vendors 106, the results, or solutions to the QUBOs, as well as associated telemetry as execution time and number of shots, may be provided by the vendors 106 to the broker 104 for comparison purposes. In an embodiment, the comparison process may comprise comparing the respective energy return, or energy states, of the various solutions obtained by the vendor 106 infrastructures. In general, the vendor hardware that produces the lowest value of some function, may be identified as the best-performing annealer.

For example, a vendor 106 solution with the lowest energy, relative to the other respective vendor 106 solutions, may be considered as the best solution although, as noted herein, the best solution may not necessarily be needed by a consumer 102. Various additional, or alternative, bases may be used to compare vendor 106 performance including, but not limited to, execution time for the QUBO problem, and the number of shots needed to achieve the solution. In an embodiment, a respective threshold may be set for any of these bases. For example, any vendor 106 with a QUBO execution time lower than a particular threshold may be identified as a viable option for the customer 102 QUBO.

In an embodiment, the vendor 106 solution and/or associated telemetry may be provided by the broker 104 directly to the customer 102 to enable the customer 102 to compare vendor 106 performance. In an embodiment, the broker 104 may retain the vendor 106 solution and/or associated telemetry, that is, without providing the vendor 106 solution and/or associated telemetry to the customer 102. In this case, the broker 104 may, itself, use the vendor 106 solution and/or associated telemetry to orchestrate the user QUBO to the vendor 106 whose performance most closely conforms with customer 102 requirements such as SLA requirements, solution fidelity, or execution time, for example. Thus, in this example, the vendor hardware comparison and selection processes are performed by the broker 104, and may be transparent to the customer 102.

### C. Further Discussion

As apparent from this disclosure, one or more embodiments of the invention may possess various useful features and aspects. For example, an embodiment may comprise a method that enables an ‘apples-to-apples’ comparison of disparate annealing vendors, regardless of the type of annealer employed, such as digital, quantum, or simulated, annealers. As another example, an embodiment may comprise a method for benchmark QUBO randomization based on size restrictions with the goal of ascertaining hardware fidelity, produced using a randomized generation of hard QUBO problems. As a final example, an embodiment may comprise a method that generates an accuracy score based on [1] how close an annealer solution was to a best known solution, and/or [2] what percentage of reads on the annealer produced a good, or acceptable, solution, where a good solution may be one which meets or exceeds a defined threshold, and what constitutes a good solution may be context dependent.

### D. Example Methods

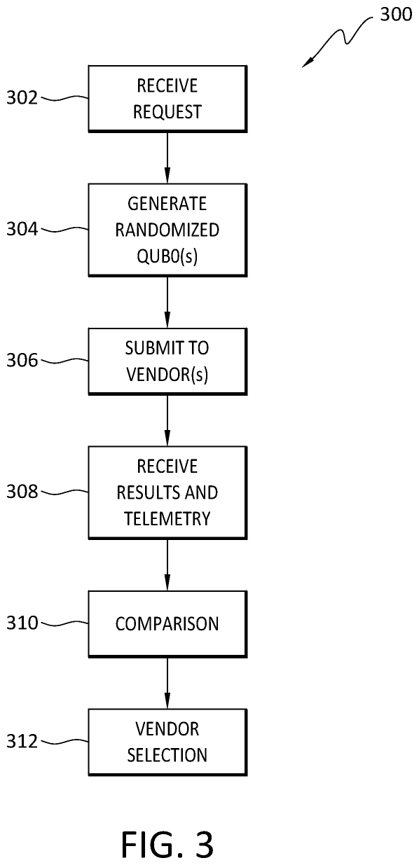

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method according to one embodiment of the invention is generally denoted at 300. In an embodiment, the method 300 may be performed in whole or in part by a broker interacting with one or more customers and one or more vendors, although that is not necessarily required. Note that where reference is made herein to a ‘customer,’ ‘consumer’ ‘vendor,’ or ‘user,’ any or all of those entities may take the form of computing entities, rather than constituting human(s).

The process 300 may begin with receipt 302, by a broker from a customer, a request. The request may comprise identification of a problem that the customer needs to solve, and/or may comprise a request that the broker evaluate the performance of one or more vendors with respect to a problem that may be similar, in terms of its computational requirements for solution, to a customer problem.

After receipt of the request 302, and possibly in response to that receipt, the broker may randomly generate 304 one or more benchmark QUBOs. In an embodiment, the randomized QUBOs may mimic various parameters, which may be user-specified, of a user QUBO that is to be solved. Further, the randomized QUBOs may be similar or identical to each other, at least in terms of the relative size and density of their respective QUBO matrices.

The randomized QUBOs may then be submitted 306 by the broker to each of the vendors whose performance is to be evaluated. At some point, each vendor may use its respective computing infrastructure to solve the QUBOs that the vendor received from the broker. The results, or solutions, obtained by each vendor, and/or telemetry generated as a result of vendor execution of the QUBOs, may then be returned to, and received by 308, the broker.

The broker may then perform a comparison 310, on a vendor basis, of the solutions and/or telemetry received 308 from the vendors. Based on the outcome of the comparison 310, the broker, or customer, may then select 312 a vendor for solution of the customer problem(s).

### E. Further Example Embodiments

Following are some further example embodiments of the invention. These are presented only by way of example and are not intended to limit the scope of the invention in any way.

Embodiment 1. A method, comprising: benchmarking each annealer in a group of annealers with respect to an ability of the annealers to resolve QUBO (quadratic unconstrained binary optimization) problems, and the benchmarking comprises; randomly generating benchmark QUBOs; obtaining information concerning execution of the benchmark QUBOs on each annealer in the group of annealers; and comparing respective performances of each of the annealers.

Embodiment 2. The method as recited in any preceding embodiment, wherein each of the benchmark QUBOs is associated with a respective QUBO matrix, and all of the QUBO matrices have a same size and same density as each other.

Embodiment 3. The method as recited in any preceding embodiment, wherein the information comprises results and/or telemetry.

Embodiment 4. The method as recited in any preceding embodiment, wherein each of the benchmark QUBOs is associated with a respective QUBO matrix, and all non-zero eigenvalues respectively associated with each QUBO matrix are assigned either a positive (+) or negative (−) sign.

Embodiment 5. The method as recited in any preceding embodiment, wherein one of the benchmark QUBOs is relatively easier to solve than another of the benchmark QUBOs.

Embodiment 6. The method as recited in any preceding embodiment, wherein the annealers are each associated with a different respective vendor site.

Embodiment 7. The method as recited in any preceding embodiment, wherein each of the benchmark QUBOs is associated with a respective QUBO matrix, and each of the QUBO matrices defines a vector comprising equal numbers of positive eigenvalues, and negative eigenvalues.

Embodiment 8. The method as recited in any preceding embodiment, wherein one or more of the annealers comprises a digital annealer, a quantum annealer, or a simulated annealer.

Embodiment 9. The method as recited in any preceding embodiment, wherein the request is received from a user and the request specifies a user QUBO to be solved, and/or specifies one or more parameters of a user QUBO to be solved.

Embodiment 10. The method as recited in any preceding embodiment, wherein solutions to each of the benchmark QUBOs comprise multiple local minima.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer and computing system may comprise quantum computing hardware, classical computing hardware, or a combination of the two. Quantum computing hardware may comprise, but is not limited to, annealers. Other annealers may comprise classical computing hardware and/or quantum computing hardware.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

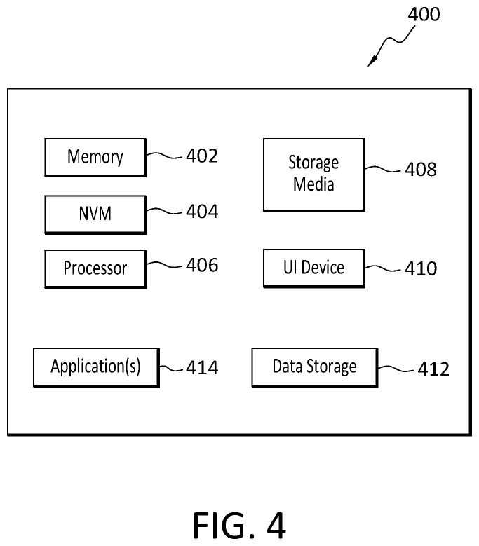

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
benchmarking each annealer in a group of annealers with respect to an ability of the annealers to resolve QUBO (quadratic unconstrained binary optimization) problems, and the benchmarking comprises;
randomly generating benchmark QUBOs;
obtaining information concerning execution of the benchmark QUBOs on each annealer in the group of annealers; and
comparing respective performances of each of the annealers.

2. The method as recited in claim 1, wherein each of the benchmark QUBOs is associated with a respective QUBO matrix, and all of the QUBO matrices have a same size and same density as each other.

3. The method as recited in claim 1, wherein the information comprises results and/or telemetry.

4. The method as recited in claim 1, wherein each of the benchmark QUBOs is associated with a respective QUBO matrix, and all non-zero eigenvalues respectively associated with each QUBO matrix are assigned either a positive (+) or negative (−) sign.

5. The method as recited in claim 1, wherein one of the benchmark QUBOs is relatively easier to solve than another of the benchmark QUBOs.

6. The method as recited in claim 1, wherein the annealers are each associated with a different respective vendor site.

7. The method as recited in claim 1, wherein each of the benchmark QUBOs is associated with a respective QUBO matrix, and each of the QUBO matrices defines a vector comprising equal numbers of positive eigenvalues, and negative eigenvalues.

8. The method as recited in claim 1, wherein one or more of the annealers comprises a digital annealer, a quantum annealer, or a simulated annealer.

9. The method as recited in claim 1, wherein a request is received from a user and the request specifies a user QUBO to be solved, and/or specifies one or more parameters of a user QUBO to be solved.

10. The method as recited in claim 1, wherein solutions to each of the benchmark QUBOs comprise multiple local minima.

11. A non-transitory storage medium having stored therein instructions that are executable by one or more hardware processors to perform operations comprising:
benchmarking each annealer in a group of annealers with respect to an ability of the annealers to resolve QUBO (quadratic unconstrained binary optimization) problems, and the benchmarking comprises;
randomly generating benchmark QUBOs;
obtaining information concerning execution of the benchmark QUBOs on each annealer in the group of annealers; and
comparing respective performances of each of the annealers.

12. The non-transitory storage medium as recited in claim 11, wherein each of the benchmark QUBOs is associated with a respective QUBO matrix, and all of the QUBO matrices have a same size and same density as each other.

13. The non-transitory storage medium as recited in claim 11, wherein the information comprises results and/or telemetry.

14. The non-transitory storage medium as recited in claim 11, wherein each of the benchmark QUBOs is associated with a respective QUBO matrix, and all non-zero eigenvalues respectively associated with each QUBO matrix are assigned either a positive (+) or negative (−) sign.

15. The non-transitory storage medium as recited in claim 11, wherein one of the benchmark QUBOs is relatively easier to solve than another of the benchmark QUBOs.

16. The non-transitory storage medium as recited in claim 11, wherein the annealers are each associated with a different respective vendor site.

17. The non-transitory storage medium as recited in claim 11, wherein each of the benchmark QUBOs is associated with a respective QUBO matrix, and each of the QUBO matrices defines a vector comprising equal numbers of positive eigenvalues, and negative eigenvalues.

18. The non-transitory storage medium as recited in claim 11, wherein one or more of the annealers comprises a digital annealer, a quantum annealer, or a simulated annealer.

19. The non-transitory storage medium as recited in claim 11, wherein a request is received from a user and the request specifies a user QUBO to be solved, and/or specifies one or more parameters of a user QUBO to be solved.

20. The non-transitory storage medium as recited in claim 11, wherein solutions to each of the benchmark QUBOs comprise multiple local minima.
